(19) United States
(12) Patent Application Publication
(10) Pub. No.: US 2024/0036431 A1
(43) Pub. Date: Feb. 1, 2024

(54) TRANSPARENT ELECTROPHORETIC DISPLAY WITH HOLLOW COMMON ELECTRODE

(71) Applicants: YAODONG MA, Frisco, TX (US); Blair Ma, Frisco, TX (US); Lilya Darlene Ma, Frisco, TX (US)

(72) Inventors: YAODONG MA, Frisco, TX (US); Blair Ma, Frisco, TX (US); Lilya Darlene Ma, Frisco, TX (US)

(21) Appl. No.: 17/815,198

(22) Filed: Jul. 26, 2022

(51) Int. Cl. G02F 1/16766; G02F 1/167; G02F 1/1679; G02F 1/1685; G02F 1/1677

(52) U.S. Cl. CPC G02F 1/16766; G02F 1/167; G02F 1/1679; G02F 1/1685; G02F 1/1677; G02F 2203/30; G02F 2203/09; G02F 2001/1678

(57) ABSTRACT

The present invention relates to an electrophoretic light shutter display, more specifically, to a multi-stable transmissive electrophoretic light shutter display employing symmetric electrode patterning. The basic unit consists of four pixels with four identical square transparent electrodes connected with quadruple thin film transistors on the first substrate, an overlapped circular electrode on the second substrate, and a cell of electrophoretic particle dispersion fluid sandwiched between the first and second substrates. When an electric pulse is applied to any one of the pixels with a predetermined polarity, the colored charged particles will be able to move fan-in or fan-out radially with a linear grayscale. Therefore, the total transmission of the incident light through the shutter can be electronically modulated and maintained for good in zero-field conditions.

### FIELD OF THE INVENTION

The present invention relates to an electrophoretic light shutter display, more specifically, to a multi-stable transmissive electrophoretic light shutter display employing symmetric electrode patterning. The basic unit consists of four pixels with four identical square transparent electrodes connected with a quadruple thin film transistor core on the first substrate, an overlapped circular electrode on the second substrate, and a cell of electrophoretic particles dispersed in a transparent liquid fluid sandwiched between the first and second substrates. When an electric pulse with predetermined polarity is applied to any one of the pixels, the colored charged particles will be able to move fan-in or fan-out radially with linear grayscales. Therefore, the total transmission of the incident light through the shutter can be electrically modulated and maintained for good in zero-field conditions.

### BACKGROUND OF THE INVENTION

The electrophoretic effect is well known, and the prior art is replete with a number of patents and articles which describe the effect. As will be recognized by a person skilled in the art, the electrophoretic effect operates on the principle that certain particles, when suspended in a medium, can be electrically charged and thereby caused to migrate through the medium to an electrode of opposite charge. Electrophoretic displays (EPDs) utilize the electrophoretic effect to produce desired images.

EPDs generally comprise a suspension of colored charged pigment particles dispersed in a dyed solvent of contrasting color, which is injected into a cell consisting of two parallel and transparent conducting electrode panels. The charged particles are transported and packed against one electrode under the influence of an electric field, so that the viewer may see the color of the pigment. When the polarity of the field is reversed, the pigment particles are transported and packed on the opposite electrode. If the optical density of the dyed solvent is high enough to absorb the light scattered by the particles residing on the rear electrode, the observer will perceive the color of the dyed solvent. The performance of the resulting display is strongly dependent upon the suspension stability.

In non-aqueous dispersions, colloid particles generally owe their stability to the fact that their surfaces are charged and, hence, repel each other. When the particles are uncharged, the dispersion is unstable. The fact that a colloidal particle bears a net surface charge is not a sufficient condition for stability because electroneutrality demands that the particle plus its immediate surroundings bear no net charge. In other words, the surface charge must be compensated by an equal but opposite counter charge, so that the surface charge and countercharge together form an electrical double layer. P. Murau and B Singer, in an article appearing in Vol. 49, No. 9 of the Journal of Applied Physics (1978) and entitled “The Understanding and Elimination of Some Suspension Instabilities in an Electrophoretic Display”, indicate that when the double layer is compressed, the particles can approach each other to within a few hundred angstroms before repulsion is felt whereupon the van der Waals attraction becomes so strong that aggregation occurs.

The interactions of particle surfaces and charge control agents in colloidal suspensions had been the subject of considerable research. Reference is made to an article entitled “Mechanism of Electric Charging of Particles in Nonaqueous Liquids” appearing in Vol. 15 of the Journal of the American Chemical Society (1982), wherein F. M. Fowkes et al discuss the mechanism of electrostatic charging of suspended acidic particles by basic dispersants in solvents of low dielectric constant. Reference is also made to an article entitled “Steric and Electrostatic Contributions to the Colloidal Properties of Nonaqueous Dispersions” appearing in Vol. 21 of the Journal of the American Chemical Society (1984) wherein F. M. Fowkes and R. J. Pugh discuss the importance of anchoring sites for steric stabilizers in minimizing particle flocculation. The essential point developed by these references is that particle surface interactions are acid-base in character. Acidic pigment surface sites and basic charge control agents yield negative pigment surface charge. On the other hand, basic pigment surface sites and acidic charge control agents yield positive pigment surface charge.

Since electrophoretic devices utilize low polarity liquids in which ionization of ordinary organic acids and salts is negligible (approximately 10⁻¹⁰ moles per liter), the charge of the particle is governed by trace impurities unless otherwise controlled by adsorbing on the pigment surface a suitable charge control agent. This amount of charge, although sufficient for electrophoretic activity may still be inadequate for electrostatic stabilization of the suspension. if the charge control agent is also polymeric, or a polymeric dispersant is present in addition, the colloid stability can be further enhanced.

As will be recognized by a person skilled in the art, the selection of the electrophoretic particles used in the EPD is very important in determining the performance of the EPD and the quality of the viewed image produced. Ideally, electrophoretic particles should have an optimum charge/mass ratio, Which is dependent upon the particle size and surface charge, to obtain good electrostatic deposition at high velocity as well as rapid reversal of particle motion when voltages change. Additionally, it is desirable to utilize electrophoretic particles that have essentially the same density as the fluid medium in which they are suspended. By using electrophoretic particles of essentially the same density as the suspension medium, the migration of the electrophoretic particles through the medium remains independent of both the orientation of the EPD and the forces of gravity. The light-colored particles are commonly inorganic pigments. Titanium dioxide, for example, has been used in EPDs to produce good optical contrast between the white particles and the colored suspension medium. However, it has a density of about 4 g/cm³, which is too high to match with any organic liquid to prevent the sedimentation problem. In the past decades, great effort has been made to solve the density problem of titanium dioxide. However, very little work has succeeded without trading off the quality of the images, especially regarding the whiteness. Coating titanium dioxide particles with a polymeric material to reduce the density of titanium dioxide is an example.

U.S. Pat. No. 4,655,897 to DiSanto et al., U.S. Pat. No. 4,093,534 to Carter et al., U.S. Pat. No. 4,298,448 to Muller et al., and U.S. Pat. No. 4,285,801 to Chaing teach a different means to utilize the light-colored titanium dioxide particles in EPDs to produce good optical contrast between the white particles and the colored suspension medium.

Useful electrophoretic displays are bistable: their state persists even after the activating electric field is removed. This is generally achieved via a residual charge on the electrodes and van der Waals interactions between the particles and the walls of the electrophoretic cell. Unfortunately, the stability of the prior art electrophoretic displays is limited. Although flocculation or settling of particles can be avoided by matching the density of the particles with that of the liquid medium, long-term particle agglomeration remains a problem. That is, cohesive forces among particles may eventually overcome dispersive forces degrading the appearance and function of the display. For example, particle agglomerations respond less efficiently to an applied field (increasing switching time) and are also more vulnerable to the action of gravity (limiting usefulness in arbitrary orientations); thus, if the display is oriented vertically, gravity can overcome adhesion to the cell wall and cause agglomerations to settle.

U.S. Pat. Nos. 5,930,026 and 5,961,804 to Jacobson et al introduce an E-ink technology, microencapsulating individual elements of an electrophoretic display. This approach eliminates the effects of agglomeration on a scale larger than the size of the capsule, which is sufficiently small to be individually unnoticeable. The E-ink is positioned between the transparent common electrode and the pixel electrodes and typically comprises multiple microcapsules having a diameter between about 10 and 50 microns. In one example of a black-and-white display, each microcapsule comprises positively charged white particles and negatively charged black particles suspended in a fluid. When a negative electric field is applied from the pixel electrode to the transparent common electrode, the negatively charged black particles move towards the common electrode and the pixel becomes darker to a viewer. Simultaneously, the positively charged white particles move towards the pixel electrode on the backplane, away from the viewer's sight. The basic function of the current e-ink device is a reflective bistable display.

### SUMMARY OF THE INVENTION

It is a primary objective of the present invention to create a transmissive electrophoretic light shutter.

It is another objective of the present invention to achieve a bistable smart window.

It is a further objective of the present invention to fabricate a multi-stable light modulator.

It is another objective of the present invention to take the advantage of the symmetric electrode structure for the TFT addressing the suspended particles in a way of fan-in and fan-out within a pixel.

It is again another objective of the present invention to create a zero-field haze-free transparent optical ON state.

It is still a further objective of the present invention to create a zero-field Lambertian opaque optical OFF state.

It is another objective of the present invention to obtain a zero-field black optical OFF state.

It is still another objective of the present invention to obtain a color image.

### BRIEF DESCRIPTION OF THE DRAWINGS

FIG. 1 illustrates a schematic quadruple TFT electrode structure built on the first substrate.

FIG. 2 illustrates a schematic circular metal electrode structure built on the second substrate.

FIG. 3 illustrates a schematic structure of an electric shielding micro-wall between the first and the second substrates.

FIG. 4 illustrates a schematic structure of a clear-and-white light shutter.

FIG. 5 illustrates a schematic structure of a clear-and-black light shutter.

FIG. 6a illustrates a schematic multi-stable migration pattern of the charged particles.

FIG. 6b illustrates another schematic multi-stable migration pattern of the charged particles.

FIG. 7 illustrates a schematic image pattern of the transparent electrophoretic light shutter display.

FIG. 8 illustrates a schematic structure of a sunlight readable PC computer.

### DETAILED DESCRIPTION OF THE INVENTION

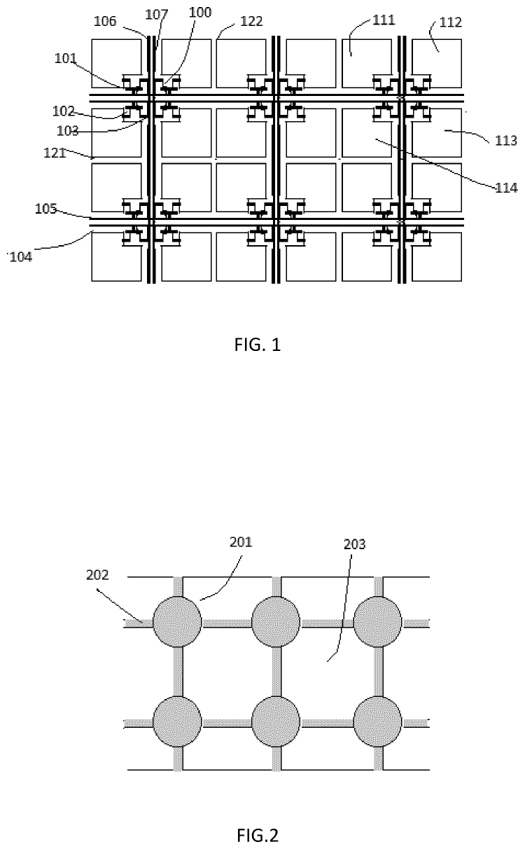

Referring to FIG. 1, illustrated is a schematic diagram of a symmetry quadruple TFT active-matrix substrate. The basic symmetrical pattern consists of four pixels with four identical square transparent electrodes 111, 112, 113, and 114 connected with a quadruple thin film transistor core 100 on the first substrate. The TFT substrate or a backplane has pixel electrodes arranged in rows 104, 105, and columns 106, and 107. The crossing between a row and a column is associated with an image pixel that is formed by a transparent ITO pixel electrode. The pixel electrode connects to the drain 102 of a transistor 100, of which the source 103 is electrically coupled to a column electrode and of which the gate 101 is electrically connected to a row electrode. This arrangement of pixel electrodes, transistors, row electrodes, and column electrodes jointly forms an active matrix. The pixel gap 121, 122 is equivalent to the wall width of a polymeric network, which will be described later.

Turning now to FIG. 2, illustrated is a schematic diagram of a common electrode substrate. A spherical metal electrode 211 and metal wire conductor 203 constructs a network deposited on glass or plastic substrate 200. The pixel area 202 is of a highly transparent flat surface without covering any conductive material, for example, ITO conductive layer. The spherical electrode allows electrophoretic charged particles to migrate radially fan-in or fan-out to the pixel electrode area upon applying electric voltage waveforms. Any metal material could be used as the common electrode, such as aluminum, copper and silver, and so on. A non-metal inorganic or organic material can be also used as the common electrode. Besides the round shape electrode, a square metal electrode design can be also adopted in the present invention.

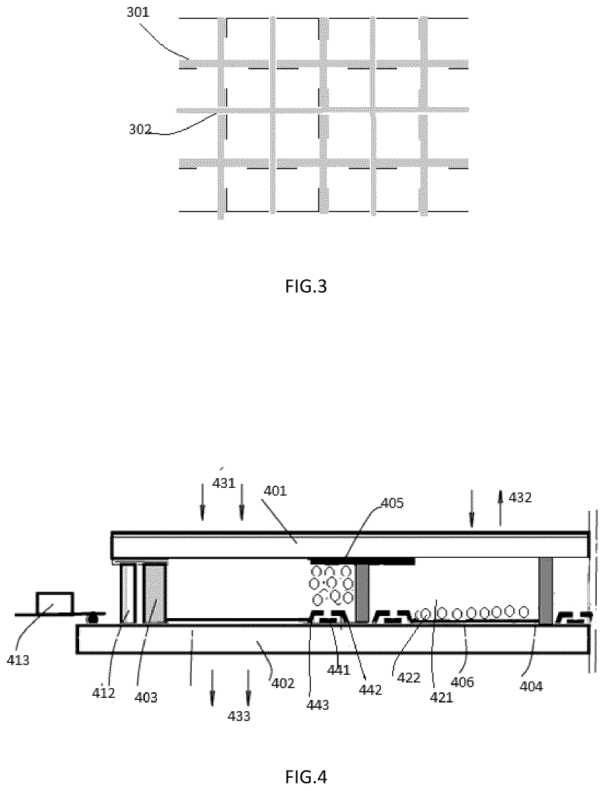

Turning now to FIG. 3, illustrated is a schematic polymeric network structure. A polymeric wall 301 structure can be built on the TFT common substrate as a standard spacer process to build an electrophoretic microcell structure. The polymer network structure can be made of a conductive polymer, such as carbon fiber doped polymer, which is electrically connected with the common electrode to avoid the field effect of the driven pixel to the adjacent pixels, the so-called cross-talk effect. The conductive micro-wall is insulated to the TFT electrode by means of a SiO₂ layer. The polymeric network comprises many discontinuous sections 302 with an opening gap of less than 1 micron, which can be made by an in-line spacer fabrication process. Since the diameter of the charged particles is on average 2 microns, which is unable to let the particle pass through the gap. In this viewpoint, the novel micro-net structure works as a filter allowing selectively the dielectric fluid to run through while eliminating the migration of charged particles from one pixel to adjacent pixels. The relative motion between the dielectric fluid and the particles may enhance the surface charge by means of the friction charge-providing effect.

As shown in FIG. 3, the wall structure is built on the color filter panel during the wet or dry patterning process, similar to the in-situ fabrication in the LCD production line. The area of the micro-wall is approximately equal to the pixel area, while the width of the wall is equivalent to the metal wire conductor. Therefore, the ITO pixel electrode of the TFT substrate is basically situated within the inner peripheral of the micro-wall structure to ensure a maximum aperture ratio. In other words, the electrophoretic particles can be able to spread out the entire pixel electrode area as addressed by a suitable electric

Turning now to FIG. 4, illustrated is a schematic structure and working principle of a clear-and-white TFT electrophoretic light shutter. The electrophoretic light shutter comprises a cell structure of electrophoretic particle dispersion 421, including white particles 422, disposed within a backplane substrate 402, a common substrate 401, a seal ring 403, and a micro-network 404. The TFT cell thickness is in the range of 5˜35 microns, more preferably 15˜25 microns. The TFT substrate or a backplane 402 has pixel electrodes 406 arranged in rows and columns. The crossing between a row and a column is associated with a pixel that is formed between a pixel electrode and a portion of the common substrate 401. The pixel electrode 406 connects to the drain 443 of a transistor 411, of which the source 442 is electrically coupled to a column electrode and of which the gate 441 is electrically connected to a row electrode. This arrangement of pixel electrodes, transistors, row electrodes, and column electrodes jointly forms an active matrix. A controller 413 is electrically connected through a z-directional conductive ball to the row driver and the column driver, which are COG (chip on glass) bonded on the backplane 402. The row driver is electrically connected to a set of rows of the electrophoretic pixel array, and the column driver is electrically connected to a set of columns of the electrophoretic pixel array. The common electrode 405 is connected to the backplane via a cross-over silver dot 412. The controller determines voltage level and waveform to write an image onto at least one electrophoretic pixel in the electrophoretic display. Applying an activation voltage between pixel electrodes and the common electrode for specified periods can create clear or white pixels in an active-matrix light shutter.

As shown in FIG. 4, when an ambient light beam 431 reaches the shutter's white particle pixel area, it will be backscattered to the viewer as a diffusive light 432; while the portion of the light reaches the display's transparent clear pixel area, it will be substantially passing through as the light 433.

The white particle 422 has a double-layer structure with a size in the range of 1˜5 microns, more preferably 2 microns. A thermoplastic polyethylene wax material is coated on the cores of the white particle as a top layer in order to match the density to each other and the dielectric liquid fluid. Meanwhile, a suitable electric charge control agent with a predetermined polarity will be embedded into the polymeric layer to build up the charge density for those particles. Generally, the charge control agent tenders a zeta potential equal to 50˜100 elementary charges on the surface of a particle 1 micron in radius; this produces sufficient electrophoretic mobility on the order of 10⁻⁴ to 10⁻⁵ cm²/V-sec. One of the embodiments of the present invention is to prepare precisely controlled uniform charged particles. Intensive research has been focused on making polyethylene micro balls as a starting material for electrophoretic charged particles. Two categories of dry powders are available now: the first polyethylene micro ball with an average size of 5 microns and a melting point of 110° C. and the second polyethylene ball with an average size of 6 microns and a melting point of 120° C. The following examples illustrate the process of making positive charged white particles.

### EXAMPLE 1

The working medium used to make electrophoretic particles according to the present invention was a commercial aliphatic solvent consisting of hydrocarbons of isoparaffinic structure as the commercial name ISOPAR G from Brenntag, CAS No 90622-57-4. The solvent has a distillation range from 161° to 173° C., with a density of 0.748 g/cm³.

In 1000 ml of this solvent, the following were suspended at room temperature with agitation:
50 g—inorganic pigment (TiO₂, average particle size 0.405 um, a product of DuPont Rutile R-902,)
50 g—encapsulating polyethylene micro ball, m.p. 110° C., average size 5 um)
6 g—surfactant, sorbitan tristearate (“SPAN 65” Sigma-Aldrich)
5 g—charge control agent, aluminum stearate (Daishin Corp Japan)

The mixture was heated to 105° C. with continued agitation, the surfactant and the CCA were dissolved completely and the polyethylene micro ball and TiO₂ particle were dispersed very uniformly. And then the temperature was increased slowly up to 109-110° C. It was discovered that as the temperature is close to the melting point of the polyethylene wax, the micro ball starts attaching to the TiO₂ particles and forming a cluster of combinations to minimize the systematic energy. At the melting temperature of 110°, or just above it, the micro ball dissolves rapidly and encapsulates TiO₂ particles completely. At this moment, a strong agitation is needed to control the dimension of the resulting microcapsule around 2 microns. Clouding and precipitation of the microcapsules from the clear solution occurred when the mixture was cooled below the melting point of polyethylene wax. The mixture when cooled down to room temperature was filtered, and the residue remaining on the filter, i.e. the encapsulated pigment particles, was washed with cold hexane to remove adhering solvent.

The positively charged white particles were uniformly distributed. A sharp maximum in the particle size distribution was found at a particle diameter of about 2 microns.

### EXAMPLE 2

In 1000 ml of ISOPAR solvent, the following were suspended at room temperature with agitation:
50 g—inorganic pigment (TiO₂, average particle size 0.405 um, a product of DuPont Rutile R-902,)
50 g—encapsulating polyethylene micro ball, m.p. 110° C., average size 5 um
4 g—surfactant, sorbitan tristearate (“SPAN 65” Sigma-Aldrich)
4 g—charge control agent, Aluminum 3-trifluoromethylphthalate

The wax-encapsulation process of the white particles was basically the same as that of example 1. The positively charged white particles were uniformly distributed. A sharp maximum in the particle size distribution was found at a particle diameter of about 2 microns.

Turning now to FIG. 5, illustrated is a schematic structure and working principle of a clear-and-black TFT electrophoretic light shutter. The electrophoretic light shutter comprises a cell structure of electrophoretic particle dispersion 421, including white particles 522, disposed within a backplane substrate 402, a common substrate 401, a seal ring 403, and a micro-network 404. The TFT cell thickness is in the range of 5˜35 microns, more preferably 15˜25 microns. The TFT substrate or a backplane 402 has pixel electrodes 406 arranged in rows and columns. The crossing between a row and a column is associated with a pixel that is formed between a pixel electrode and a portion of the common substrate 401. The pixel electrode 406 connects to the drain 443 of a transistor 411, of which the source 442 is electrically coupled to a column electrode and of which the gate 441 is electrically connected to a row electrode. This arrangement of pixel electrodes, transistors, row electrodes, and column electrodes jointly forms an active matrix. A controller 413 is electrically connected through a z-directional conductive ball to the row driver and the column driver, which are COG (chip on glass) bonded on the backplane 402. The row driver is electrically connected to a set of rows of the electrophoretic pixel array, and the column driver is electrically connected to a set of columns of the electrophoretic pixel array. The common electrode 405 is connected to the backplane via a cross-over silver dot 412. The controller determines voltage level and waveform to write an image onto at least one electrophoretic pixel in the electrophoretic display. Applying an activation voltage between pixel electrodes and the common electrode for specified periods can create clear or white pixels in an active-matrix light shutter.

As shown in FIG. 5, when an ambient light beam 431 reaches the shutter's black particle pixel area, it will be completely absorbed and the shutter is in an optical OFF state; while the portion of the light reaches the display's transparent dear pixel area, it will be substantially passing through as the light 433 and the shutter is in optical ON state.

The black particle 522 has a double-layer structure with a size in the range of 1˜5 microns, more preferably 2 microns. A thermoplastic polyethylene wax material is coated on the cores of the black particle as a top layer in order to match the density to each other and the dielectric liquid fluid. Meanwhile, a suitable electric charge control agent with a predetermined polarity will be embedded into the polymeric layer to build up the charge density for those particles. Generally, the charge control agent tenders a zeta potential equal to 50˜100 elementary charges on the surface of a particle 1 micron in radius; this produces sufficient electrophoretic mobility on the order of 10⁻⁴ to 10⁻⁵ cm²/V-sec. One of the embodiments of the present invention is to prepare precisely controlled uniform charged particles. Intensive research has been focused on making polyethylene micro ball as a starting material for electrophoretic charged particles. Two categories of dry powders are available now: the first polyethylene micro ball with an average size of 5 microns and a melting point of 110° C. and the second polyethylene ball with an average size of 6 microns and a melting point of 120° C. The following examples illustrate the process of making positive charged white particles and negative charged black particles.

### EXAMPLE 3

In 1000 ml of ISOPAR solvent, the following were suspended at room temperature with agitation:
50 g—inorganic pigment (Carbon Black, Raven 1250, average particle size ≤1um, density 2.0 g/cm³, produced by Columbia Carbon C., Ltd)
25 g—encapsulating polyethylene micro ball, m.p. 110° C., average size 5 um
4 g—surfactant, sorbitan tristearate (“SPAN 65” Sigma-Aldrich)
3 g—charge control agent, copper oleate (Sigma-Aldrich)

The wax-encapsulation process of the black particles was basically the same as that of example 1. The negatively charged black particles were uniformly distributed. A sharp maximum in the particle size distribution was found at a particle diameter of about 2 microns.

3 g of the polyethylene encapsulated positive particles and 3 g negative particles thus obtained were stirred into a mixture (dielectric liquid fluid) consisting of 55 ml liquid paraffin (“perliquidum”, DAB 6, density 0.83 to 0.87 g/cm³, maximum viscosity about 65 cP) and 45 ml of Tetrachloroethylene (density 1.622 g/cm³, viscosity 0.89 cP). In order to produce the EPID suspension, the resulting mixture was homogenized for about 10 seconds using ultrasound before application.

$$t = \frac{6 π {d}^{2} η}{V ∈ ζ}$$

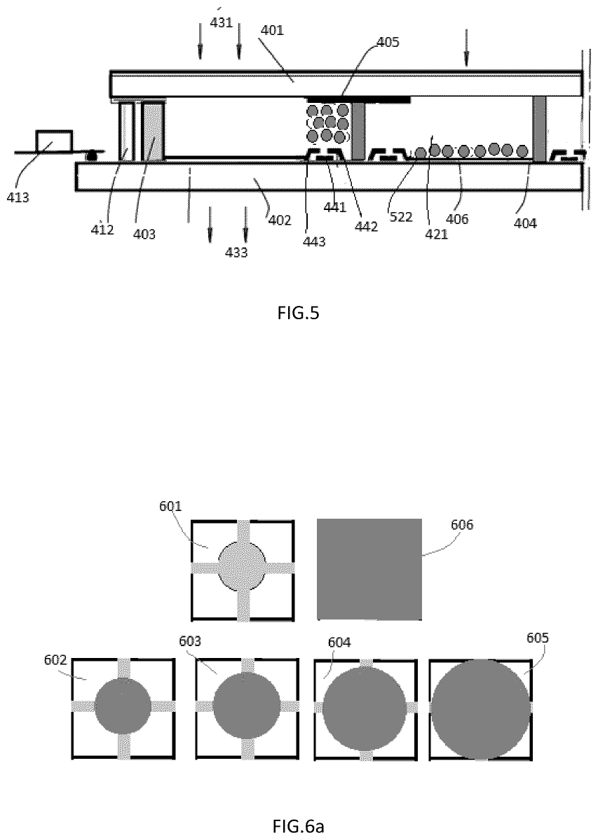

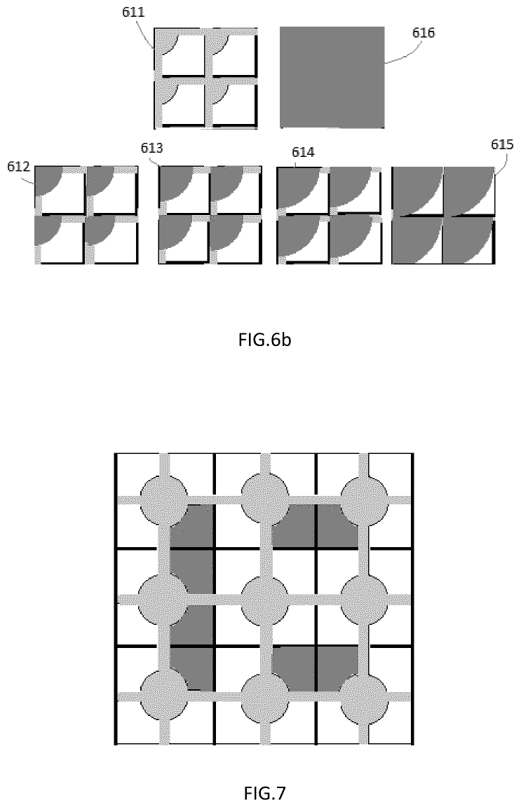

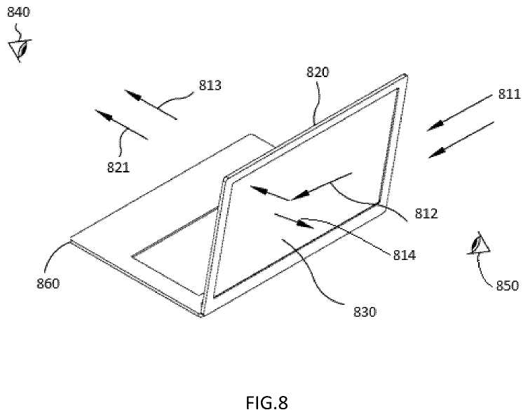

Turning now to FIG. 6a illustrated is a schematic structure of a testing sample with a single pixel, wherein a transparent ITO substrate and a circular electrode deposited substrate superimposed to form a shutter with a cell gap of 25 microns. The shutter is directly connected to a DC power supply without a TFT driver. The multi-stable migration pattern of the charged particles inside the light shutter can be described as follows. The pixels 601, and 606 represent a transparent optical ON state and a black optical OFF state respectively, while pixels 602, 603, 604, and 605 demonstrate the grayscale levels with different ratios of the black area to white area according to different voltage pulses. The symmetrical pixel cell design in the present invention allows the population of the particles to migrate radially from the circular electrode to the transparent square electrode gradually (fan-out process). Each optical state or grayscale can be fixed depending on the intensity or the duration of the external electric voltage. When the electric voltage with opposite polarity is applied to the dielectric liquid fluid fraught with charged particles, the reverse process of particle migration will take place (fan-in process). And the fan-in or fan-out process can be repeated thousands and thousands of times with approximately the same patterning. The switching time of suspended particles located between two electrodes is given by

$$t = \frac{6 π {d}^{2} η}{V ∈ ζ} \qquad ( 1 )$$

Where d is the distance between electrodes, η is the viscosity of the liquid medium, ∈ is the dielectric constant, V is the potential difference between the electrodes, and is the zeta potential of the particles. The quantity t represents the time required for charged particles to migrate from one of the electrodes to the other. According to the symmetrical pixel design of the present invention, the relationship between the switching time and the grayscale level can be derived as follows. The black area A is governed by formula 2.

A=πd² (2)

Suppose the cell gap is sufficiently small compared with the side length of the square pixel cell and the particles migrate from the square center, one can combine formula 1 and formula 2 into formula 3:

$$t = \frac{6 η}{V ∈ ζ} A \qquad ( 3 )$$

One may realize immediately that the switching time t has a linear relationship with the grayscale A=ƒ(d). In the case of a constant applied voltage and all other parameters remaining the same, the grayscale is directly proportional to the switching time. In the case of square wave pulses, the grayscale is directly proportional to the number of pulses. Therefore, a multi-stable clear-and-black electrophoretic light shutter is achieved. This is the theoretical background of the present invention. Practically, the shutter can be used as a smart window, a displayable window.

Turning now to FIG. 6b, illustrated is another schematic structure of a testing sample with a single pixel, wherein a transparent ITO substrate and a metal electrode deposited substrate superimposed to form a shutter with the cell gap of 25 microns. The shutter is directly connected to a DC power supply without a TFT driver. The multi-stable migration pattern of the charged particles inside the light shutter can be described as follows. Pixels 611, and 616 represent a transparent optical ON state and a black optical OFF state respectively, while pixels 612, 613, 614, and 615 demonstrate the grayscale levels with different ratios of the black area to the white area. The symmetric pixel cell design in the present invention allows the population of the particles to migrate radially from the circular electrode to the transparent square electrode gradually (fan-out process). Each optical state or grayscale can be fixed depending on the intensity or the duration of the external electric voltage. When the electric voltage with opposite polarity is applied to the dielectric liquid fluid fraught with charged particles, the reverse process of particle migration will take place (fan-in process). And the fan-in or fan-out process can be repeated thousands and thousands of times with approximately the same patterning.

Turning now to FIG. 7, illustrated is a schematic image pattern of the 6×6 active matrixes transparent electrophoretic light shutter display. A Japanese character is shown in such a simple matrix. Since there is only one layer of ITO electrode in the effective display area and the fact that the color-less dielectric fluid is filling in the cell, the total transmission of the panel is over 80%, which is the highest currently available electronic displays. On the other hand, since it is characterized by bistability or multistability, the display renders a flicker-free image. No power is needed to maintain the image once it has been addressed. Above all, there is no human eye fatigue effect involved in such a transparent display. Similarly, the transparent display can be converted to a reflective display by attaching a white film to the back substrate. If the white film is a perforated white coating, for example, a barium sulfate painting, and a back-lit panel is positioned behind the white film as well, the display will be transflective. Furthermore, besides the black and white display, a red, green, and blue color filter layer can be deposited on the common substrate with circular electrodes, wherein the R, G, and B colors occupy three-quarters of the quadruple TFT electrode respectively, and one quarter is left empty for the white color. Thus, the red, green, blue, and white colors will be occupied the symmetrical pixel structure. Thus, a full color transflective multistable display with linearly controllable gray scales is constructed.

Turning now to 8, illustrated is a schematic structure of a sunlight readable PC computer. The computer is substantially similar to a conventional PC except for a transparent electrophoretic light shutter display 530 opening on the back lid. An internal backlight unit and a TFT LCD panel within the housing 520 are of approximately the same area as the electrophoretic display 530. The substantially transparent display panel 530 can be embedded on the back lid.

### 1. Shutter ON Mode

During the daytime in an outdoor application, a beam of sunlight 511 passing through the electronic window 530 becomes light beam 512. It proceeds to pass through a built-in backlight structure and a LCD panel as a fun-color image 513 to a viewer 540. Meanwhile, the built-in backlight structure will generate an artificial color imaging light 521 to the viewer 540. The color image 513 illuminated by the sunlight may be much brighter than that of the 521 so that the internal backlit can be automatically attenuated or even completely turned off.

### 2. Shutter OFF Mode

In indoor applications or a dimmed outdoor environment, the electrophoretic light shutter 530 is set in an optical OFF state. There will be no internal backlight leaking out of the light shutter. The PC is back to the normal working mode and the built-in backlight is fully responsible for the generation of the color image 521.

### 3. Display Mode

Whenever it is needed the electrophoretic light shutter can be turned to a reflective display mode or an E-book mode so that a viewer 850 will discern a black-and-white image 814 from the back lid of the computer. The dual display mode can be also set up when two views 840, and 850 opposite to the device watch their content simultaneously, in a convertible display mode, the back lid of the PC may be also flipped back to the keyboard 860 and the device becomes a tablet E-reader.

In the U.S. Pat. No. 7,853,288, the applicant discloses a sunlight illuminated and sunlight readable mobile phone, which is incorporated herein by reference. The display panel opens a transparent window to the ambient light, which allows the sunlight to illuminate the display in both indoor and outdoor applications.

In the U.S. Pat. App. No. 20140043565, the applicant discloses a sunlight readable full-color active-matrix liquid crystal display device by means of light guiding films, which is incorporated herein by reference.

In the U.S. Pat. App. No. 20150002781, the applicant discloses a sunlight readable full-color active-matrix liquid crystal display device by means of an electric controllable light shutter, Which is incorporated herein by reference.

1. A linear grayscale electrophoretic light shutter comprising:
a. a first transparent substrate with a plural circular metal electrodes structure,
b. a second transparent electrode substrate with at least one pixel,
c. a seal ring,
d. a charged color particles dispersed dielectric fluid,
e. an electric driving circuit,
wherein the first and the second substrates and the seal ring are juxtaposed to form a cell structure, the charged particle dispersed dielectric fluid is positioned between the substrates, wherein the electric driving circuit generates electric pulses, applied to the pixel with a predetermined polarity, and drives the charged color particles in a way of radially fan-in or fan-out migration around the circular electrode within the cell structure, while the contrast ratio is directly proportional to the duration or the number of the electric pulses, whereby the total transmission of the incident light through the shutter can be electronically modulated and be maintained for good in zero-field condition.

2. A linear grayscale electrophoretic light shutter as claimed in claim 1, wherein the cell thickness is in the range of 5˜35 microns.

3. A linear grayscale electrophoretic light shutter as claimed in claim 1, wherein the charged color particle is of the dimension in the range of 1˜2 microns.

4. A linear grayscale electrophoretic light shutter as claimed in claim 1, wherein the charged color particle is a carbon black particle.

5. A linear grayscale electrophoretic light shutter as claimed in claim 1, wherein the charged color particle is a titanium dioxide white particle.

6. A linear grayscale electrophoretic light shutter as claimed in claim 1, wherein the charged color particle is a color particle.

7. A linear grayscale electrophoretic light shutter as claimed in claim 1, wherein the light shutter is a brightness controllable window.

8. A linear grayscale electrophoretic light shutter display comprising:
a. a first transparent conductive substrate with a quadruple TFT electrode structure,
b. a second transparent substrate with plural circular metal electrode structure,
c. a black particle dispersed dielectric fluids,
d. an electric shielding micro-wall structure,
e. a seal ring,
wherein the first and the second substrates and the seal ring are juxtaposed to form a cell structure, the charged particle dispersed dielectric fluid is positioned between the substrates, wherein the quadruple TFT electrode structure on the first substrate and the circular metal electrodes structure on the second substrate are overlapped to form a charged particles radiation center area, wherein the electric shielding micro-wall structure localizes the electric field in the enclosed pixel area, wherein the TFT drives charged black particles, with a predetermined polarity, in a way of radially fan-in or fan-out migration around the circular electrode within the cell structure, while the contrast ratio is directly proportional to the duration or the number of the electric pulses, whereby the total transmission of the incident light through the shutter display can be electronically modulated to form an image with multiple grayscales.

9. A linear grayscale electrophoretic light shutter display as claimed in claim 8, wherein the shutter display is a transparent displayable window.

10. A linear grayscale electrophoretic light shutter display as claimed in claim 8, wherein the shutter display is a black-and-white display.

11. A linear grayscale electrophoretic light shutter display as claimed in claim 8, wherein the shutter display is a transflective display.

12. A linear grayscale electrophoretic light shutter display as claimed in claim 8, wherein the electric shielding micro-wall structure is of a carbon-doped polyacrylic polymer structure.

13. A linear grayscale electrophoretic light shutter display further including a red, green, and blue color filter layer deposited on the second substrate.

14. A linear grayscale electrophoretic light shutter display as claimed in claim 13, wherein the shutter display is a full-color display.

15. A linear grayscale electrophoretic light shutter display as claimed in claim 8, wherein the quadruple TFT electrode structure unit is a red, green, blue, and white pixel addressing unit.

16. A linear grayscale electrophoretic light shutter display as claimed in claim 8, wherein the quadruple TFT electrode structure is a symmetric electrode patterning.

17. A linear grayscale electrophoretic light shutter display further includes a lighting panel.

18. A linear grayscale electrophoretic light shutter display as claimed in claim 17, wherein the lighting panel is a back-lit panel.

19. A linear grayscale electrophoretic light shutter display as claimed in claim 8, wherein the shutter display is a sunlight shutter for a sunlight readable PC.

20. A linear grayscale electrophoretic light shutter display as claimed in claim 8, wherein the shutter display is the second display for a double-side readable PC.
